(19) United States
(12) Patent Application Publication
(10) Pub. No.: US 2026/0358858 A1
(43) Pub. Date: Nov. 12, 2026

(54) MODULAR PROCESSING DEVICES

(71) Applicant: Kid Company, Los Altos, CA (US)

(72) Inventor: Robert LoCascio, Los Altos, CA (US)

(73) Assignee: Kid Company, Los Altos, CA (US)

(21) Appl. No.: 19/406,343

(22) Filed: Dec. 2, 2025

Related U.S. Application Data
(63) Continuation-in-part of application No. 19/202,989, filed on May 8, 2025.

(51) Int. Cl. G06F 1/16; G06F 3/041

(52) U.S. Cl. CPC G06F 1/1637; G06F 1/1686; G06F 1/1688; G06F 1/1698; G06F 3/0412

(57) ABSTRACT

A modular processing device comprises a spherical cap with a cavity. One or more processing modules may be positioned within the cavity of the spherical cap. The one or more processing modules may include a processor and memory. The modular processing device may include a touch-based display positioned over a base of the spherical cap. The touch-based display is electrically coupled to a processing module of the one or more processing modules. The modular processing device includes one or more connectors configured to removably affix components configured to augment the spherical cap.

### CROSS-REFERENCE TO RELATED APPLICATIONS

The present patent application claims the benefit of priority to U.S. patent application Ser. No. 19/202,989 filed May 8, 2025, which is incorporated herein by reference in its entirety for all purposes.

### TECHNICAL FIELD

This disclosure relates generally to processing devices, and more particularly to spherical processing devices with modular configurations of extended functionality.

### BACKGROUND

Processing devices generally come in standard square or rectangular configurations to accommodate common processing workloads. Display devices, whether standalone or built into the processing device, also come in similar complimentary (“standard”) configurations. For example, rectangular displays are well suited for word processing, fixed media, etc. While these standard configurations may be efficient for common processing workloads, the standard configurations may not be suitable for non-common workloads such as processing tasks that use unique input devices, processing unique datasets, have varying processing requirements etc.

### SUMMARY

Processing systems are described herein. An example processing system may comprise: a spherical cap comprising a cavity; one or more processing modules positioned within the cavity of the spherical cap, wherein the one or more processing modules include a processor and memory; a touch-based display positioned over a base of the spherical cap, wherein the touch-based display is electrically coupled to a processing module of the one or more processing modules; and one or more connectors configured to removable affix components configured to augment the spherical cap.

Other example processing system may comprise: a spherical cap comprising a cavity; a first circuit positioned within the cavity of the spherical cap, wherein the first circuit comprises a processor, memory, and a power management module; a power supply positioned within the cavity of the spherical cap, wherein the power supply is electrically coupled to the power management module of the first circuit, and wherein the power supply provides power to the first circuit; a touch-based display positioned over a base of the spherical cap; a second circuit positioned within the cavity of the spherical cap and configured to drive the touch-based display, wherein the second circuit is electrically coupled to the first circuit, and wherein the second circuit receives power from the power supply through the first circuit; and one or more connectors positioned on an exterior surface of the spherical cap, wherein the one or more connectors are configured to removably affix one or more components to the spherical cap.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features, embodiments, and advantages of the present disclosure are better understood when the following Detailed Description is read with reference to the accompanying drawings.

FIG. 1 illustrates a front view of an example modular processing device according to aspects of the present disclosure.

FIG. 2 illustrates example aspects of a modular processing device according to aspects of the present disclosure.

FIG. 3 illustrates a rear view of an example modular processing device according to aspects of the present disclosure.

FIG. 4 illustrates a bottom view of an example modular processing device separated from a stand according to aspects of the present disclosure.

FIG. 5 illustrates a example configuration of a modular processing device including spherical handles affixed to the modular processing system according to aspects of the present disclosure.

FIG. 6 illustrates another example configuration of a modular processing device including to spherical handles affixed to the modular processing device according to aspects of the present disclosure.

FIG. 7 illustrates another example configuration of a modular processing device including to a flywheel attached to the modular processing device to allow for execution of particular functions of the modular processing device according to aspects of the present disclosure.

FIG. 8 illustrates a block diagram of example processing modules of a modular processing device according to aspects of the present disclosure.

FIG. 9 illustrates an example computing device architecture of an example modular processing device according to aspects of the present disclosure.

### DETAILED DESCRIPTION

Systems are described herein for modular processing devices. Current processing devices are designed to implement common workloads. As such, current processing devices include standard sizes and shapes, input devices, processing capabilities, etc., which limits the ability of the current processing devices to implement diverse workload types, etc. The modular processing devices described herein include one or more wireless and/or wired connectors configured to expand the functionality of the modular processing devices. For example, the components can be attached to implement particular functionality and/or expand processing capabilities.

In some examples, the modular processing devices described herein may include a spherical cap comprising a plastic or metal material that provides a rigid structure such as, but not limited to, acrylonitrile butadiene styrene (ABS), acrylic, fiberglass, steel, polycarbonate, aluminum, combinations thereof, and/or the like. The spherical cap includes a cavity configured to house one or more processing modules of the modular processing device. The one or more processing modules may include a processor module, a display driver, a speaker driver, one or more sensors drivers, one or more radios, a power management modules, combinations thereof, and/or the like. The cavity may also house other modules such as, but not limited to, a power source (e.g., such as a battery, etc.), one or more speakers, one or more sensors, one or more cameras, a coolant assembly (e.g., including one or more of fans, heatsinks, liquid coolant, combinations thereof, and/or the like), light sources (e.g., such as light emitting diodes configured to emit in a range of colors, etc.), combinations thereof, and/or the like.

The modular processing device may be manufactured to include the same, similar, or different one or more processing modules than other modular processing devices. In addition, the modular processing device may be augmented by adding or removing processing modulars to add, remove, or update the processing capabilities of the modular processing device. For example, each processing modular may include a circuit (e.g., such as a printed circuit board, etc.) that may be connected to a primary circuit (e.g., such as the processor module or a bus module, etc.). The circuit of each processing modular may include drivers, firmware, kernel, and/or the like to enable interconnectivity between circuits.

A display may be positioned over the base of the spherical cap and facing away from the cavity. The display may be the same shape as the base (e.g. circular, etc.). The display may be comprised of one or more layers of a transparent or translucent material such as glass or plastic. In some examples, the display may be a touch-based display that allows operation of the modular processing device via touch. In those examples, conductive layers may be dispersed between the one or more layers of a transparent or translucent material. The conductive layers may include but are not limited to indium tin oxide (ITO), polyethylene terephthalate, silver nanowires, graphene, and/or the like.

The touch-based display may be capacitive, resistive, infrared, and/or the like. A microphone may be positioned proximate to the display. The display may include aperture that enables sound waves to reach the microphone. The position of the microphone and the aperture allow for improved audio reception for audio originating proximate to the base of the spherical cap while reducing interfering sound waves originating from other directions of the spherical cap. In some examples, the modular processing device may be operated using touch (as previously described) and/or using voice commands (e.g. via the microphone). One or more cameras may also be positioned proximate to the display allowing for capturing images and/or video in the direction of the display. The modular processing device may include one or more additional cameras configured to capture images and/or video in other directions of the spherical cap.

The spherical cap may include one or more connectors configured to connect the modular processing device to components and/or other modular processing devices. For example, the one or more connectors may be configured to removably affix the spherical cap to a stand that enables positioning the spherical cap on a surface while preventing the spherical cap from rolling. For another example, the one or more connectors may be configured to removably affix one or more handles to the spherical cap (e.g., to enable moving the modular processing device, operation of the display, particular functionality of the modular processing device, etc.). In still yet another example, the one or more connectors may be configured to removably affix the spherical cap to another spherical cap to expand the processing capabilities (and display capabilities) of the spherical cap. When connected to another spherical cap, the modular processing device may dynamically define a primary spherical cap and designate connected spherical caps as secondary spherical caps. Sensors of the spherical caps may be used to define an orientation of the displays.

The spherical cap may include one or more different connector types. The connector type may include a pressure fitting, threads, magnets, bearings (e.g., enabling near-frictionless rotation while connected, etc.), combinations thereof, and/or the like. Each connector may include an electrical connection that electrically couples the attached component to the processing modules within the spherical cap. The electrical connection may provide power from the component and to the processing modules within the spherical cap or from the processing modules and to the connected component. The electrical connection may provide a data connection between the processing modules within the spherical cap and the connected component. Alternatively, or additionally, the component may connect to processing modules of the spherical cap via one or more wireless connections(e.g., Wi-Fi, Bluetooth, Zigbee, Z-wave, and/or the like). The one or more connectors may be internal connectors or external connectors. Internal connectors may be configured to receive a corresponding external connector affixed to a component. External connectors may extend from an outer surface of the spherical cap and engage a corresponding internal connector of the component.

For example, the spherical cap may include an upper portion (e.g., the surface of the spherical cap that is above the base), a lower portion (e.g., the surface of the spherical cap that is below the base), a left portion (e.g., the surface of the spherical cap that is to the left of the base), and a right portion (e.g., the surface of the spherical cap that is the right of the base). The spherical cap may include a magnetic connector positioned proximate to the lower portion of the spherical cap and comprising a first polarity. A base module may include a corresponding magnetic connector that is an opposing polarity from the first polarity that removably affixes base to the magnetic connector of the spherical cap.

The spherical cap may include one or more electrical ports and/or access ports. The one or more electrical ports may be electrically coupled to the processing modules of the spherical cap. The one or more electrical ports may be connected to a power management module (e.g., configured to charge the power source and/or provide power to the processing modules of the spherical cap, etc.). The one or more electrical ports may also provide a data connection between the processing modules and one or mor external devices such as display devices (e.g., monitors, projectors, televisions, etc.), processing devices (e.g., computers, servers, databases, storage devices, media streaming devices, etc.), other modular processing devices, networks, sensors, combinations thereof, and/or the like. The one or more access port may provide access to the cavity of the spherical cap for adding and/or removing circuits. The circuits may be connected to the primary module via a pressure fitting allowing circuits to be removed by pulling a circuit away from the primary module and allowing for circuits to be added by pushing the circuit into an open coupling point of the primary module. In some instances, such as when the modular processing device is not configured for modification, the access port may be omitted and/or covered to prevent access to the cavity of the spherical cap.

An illustrative example modular processing device includes a spherical cap comprising a cavity. A spherical cap may be a portion of a sphere bounded by a single plane. In some instances, the spherical segment (e.g., a portion of a sphere that is bounded by two planes, etc.) may be used in place of a spherical cap. The spherical cap may be comprised of one or more materials such as plastic (e.g., acrylonitrile butadiene styrene, polycarbonate, etc.), metal (e.g., aluminum, etc.), combinations thereof, and/or the like.

One or more processing modules may be positioned within the cavity of the spherical cap. Each processing module may include one or more printed circuit boards, circuits, integrated circuits, and/or the like. In some examples, a first processing module may be a primary processing module that includes a processor and one or more memory modules (e.g., volatile memory, non-volatile memory, and/or the like). The primary processing module may also include one or more transceivers (e.g., configured to communicate via Wi-Fi, Bluetooth, Zigbee, Z-wave, etc.), power management modules, specialized memory (e.g., low power double data rate (LPDDR) memory, read only memory, cache memory, and/or the like), combinations thereof, and/or the like. Other processing modules may include a display board (e.g., including display drivers, touch-interface drivers, a camera, a microphone, memory, and/or the like), motion tracking sensors (e.g., gyroscope, accelerometer, combination thereof, and/or the like, environmental sensors (e.g., temperature, hygrometer, pressure, combinations thereof, and/or the like), one or more microphones, a speaker array, haptic drivers, a power supply, a power charging regulator (e.g., for charging the power supply and regulating power from the power supply, etc.), a universal serial bus circuity and/or interface converter (e.g., for converting between USB and universal asynchronous receiver/transmitter (UART), etc.), one or more cameras, light emitting diode arrays (e.g., for lighting the cavity of the spherical cap, an external surface of the spherical cap, and/or the like), combinations thereof, and/or the like.

The primary processing module may include software that may be executed by the processor of the primary processing module (or by other processors of other processing modules). The software may include an operating system, one or more application, one or more functions, one or more application programming interface (e.g., for interfacing with other modular processing devices, external devices, other processing modules, etc.), firmware, drivers (e.g., for interfacing with one or more hardware components attachable to the modular processing device, and/or the like).

Each processing module may connect to the primary processing module and/or to each other processing module. The connection may use a transmission protocol based on the data being transmitted over the connection, the source processing module, the destination processing module, and/or the like. For example, some connections may be based on inter-integrated circuit (I2C), inter-integrated circuit sound (I2S) for audio-based data such as microphones or speakers, camera serial interface 2 (CSI-2) for visual data from cameras, serial peripheral interface (SPI) for sensors and/or other peripherals, digital microphone (DMIC) for audio data such as microphones, display serail interface (DSI) for visual data such as visual data transmitted to and/or from a display, DisplayPort (for visual data such as visual data transmitted to and/or from a display), high-definition media interface (HDMI) for visual data such as visual data transmitted to and/or from a display, and/or the like.

The base of the spherical cap may comprise a touch-based display. The touch-based display may present images and/or video, receive input, etc. The touch interface may be capacitive, resistive, infrared-based, combinations thereof, and/or the like. The touch-based display may be electrically coupled to a processing module such as the primary processing module or a display board that is electrically coupled to the primary processing module. The touch-based interface may be used to provide input to the modular processing device, control operations and/or execute functions of the modular processing device, etc.

The external surface of the spherical cap may include one or more connectors configured to removable affix components configured to augment the spherical cap such as software executing on the one or more processing modules. Each connector may be an internal connector (e.g., aperture configured to receive an external connector of a component) or an external connector (e.g., a material that extends from an external surface of the spherical cap or component that is configured to be received by and affixed to an internal connector, etc.). In some configurations, the connectors may include an electrical connection to the primary processing module. The electrical connection enables the modular processing device to provide power to the components affixed to the modular processing device and/or enables the components to provide power to the modular processing device. Alternatively, or additionally, the electrical connection may enable data to be transferred between processing modules and the component. Alternatively, and/or additionally, a data connection (e.g., an alternate data connection and/or a parallel connection) may be established using a transceiver of a processing module (e.g., such as Bluetooth, Wi-Fil, etc.).

The modular processing device may use the data connection to identify the component, determine capabilities of the component, execute one or more functions and/or applications of the modular processing device, and/or the like. For example, connecting a flywheel to the modular processing device may trigger execution of a driving application that presents a virtual environment including a car, a boat, a plane, a spaceship, or the like. The driving application may use motion tracking sensors (e.g., accelerometers and gyroscopes), to track a position and/or orientation of the modular processing device such that moving the flywheel (e.g., rotation, or other movement) causes a corresponding rotation in the view of the virtual environment and the car, boat, plane, spaceship, etc. by the display of the modular processing device.

In some examples, the modular processing device may rotate the presentation by the display so that the display is oriented according to a user. For instance, the modular processing device may have default orientation so that the display presents content accessible to the user (e.g., text is oriented right size up, etc.). The modular processing device may shift the orientation of the display based on a corresponding movement of the modular processing device. From a default orientation where the user is facing the display of the modular processing device, the modular processing device may shift the presentation of the display when the modular processing device detects a change in pitch (e.g., latitudinal movement along an x-axis), yaw (e.g., longitudinal movement along a y-axis), and/or roll (e.g., rotation movement), etc. In some instances, the modular processing device may only shift the presentation of the display according to roll so that the presentation of the display is always up (relative to the user viewing the display). The shift may be one-to-one (e.g., each degree change in pitch, yaw, and/or roll causes a corresponding degree change in the presentation) or proportional (e.g., a change of ‘x’ for pitch, ‘y’ for yaw, and/or ‘z’ for roll may cause a change in the presentation that is ‘ax’ for the pitch, ‘by’ for the yaw, and/or ‘cz’for the roll where a, b, and c are real numbers).

Examples of connectors include, but are not limited to, a pressure fitting, a locking fitting (e.g., such as bearing-based fitting, etc.), a threaded fitting (e.g., where the internal connector includes threads that engage corresponding threads of an external connector, etc.), magnetic fitting, and/or any other removable fitting. For example, a connector of the spherical cap may include a threaded fitting in which an internal connector of the spherical gap may include threads that engage corresponding threads of an external connector extending from a surface of the connector. For another example, a connector of the spherical cap may be a magnetic connector comprising a magnetic covered by a plate that may flush with the outer surface of the spherical cap. A component may comprise a magnet comprising an opposite polarity from the magnet of the spherical cap such that the attractive forces of the two magnetics cause the spherical cap to be removably affixed to the component.

The spherical cap may be removably affixed to a stand configured to allow operation of the touch-based display while the spherical cap is positioned on a surface by preventing rotation of the spherical gap. The stand may be a spherical segment comprising a first base proximate to a surface and a second base configured to be removable affixed to a connector of the spherical cap. The connector may be positioned on a lower portion of the spherical cap (e.g., below the display, etc.) such that when affixed to the stand the display is facing a user (e.g., approximately perpendicular to the surface, etc.), facing up (e.g., approximately parallel to the surface and facing away therefrom, etc.), or in any other position so as to allow for the operation of the spherical cap and/or any function thereof. In some instances, the connector may be a magnetic connector.

One or more components may be removably affixed to the modular processing device. Each component connected to the modular processing device may augment the functionality of the modular processing device. Alternatively, and/or additionally, the functionality of the modular processing device may be based on which connector the component is connected to. The functionality may be augmented by executing particular functions, executing particular applications, modifying the display of the modular processing device (e.g., such as to adjust for changes detected in the position and/or orientation of the modular processing device, etc.).

Another example configuration of a modular processing device may include: a spherical cap comprising a cavity. A spherical cap may be a portion of a sphere bounded by a single plane. In some instances, the spherical segment (e.g., a portion of a sphere that is bounded by two planes, etc.) may be used in place of a spherical cap. The spherical cap may be comprised of one or more materials such as plastic (e.g., acrylonitrile butadiene styrene, polycarbonate, etc.), metal (e.g., aluminum, etc.), combinations thereof, and/or the like.

The modular processing device may include a first circuit (e.g., also referred herein to as a processing module, etc.) modular processing device. The first circuit may include one or more printed circuit boards, circuits, integrated circuits, and/or the like. In some examples, the first circuit may be a primary processing module that includes a processor, one or more memory modules (e.g., volatile memory, non-volatile memory, and/or the like), and/or a power management module. The primary processing module may also include one or more transceivers (e.g., configured to communicate via Wi-Fi, Bluetooth, Zigbee, Z-wave, etc.), power management modules, specialized memory (e.g., low power double data rate (LPDDR) memory, read only memory, cache memory, and/or the like), combinations thereof, and/or the like. In some examples, first circuit may also include one or more of a display board (e.g., including display drivers, touch-interface drivers, a camera, a microphone, memory, and/or the like), motion tracking sensors (e.g., gyroscope, accelerometer, combination thereof, and/or the like, environmental sensors (e.g., temperature, hygrometer, pressure, combinations thereof, and/or the like), one or more microphones, a speaker array, haptic drivers, a power supply, a power charging regulator (e.g., for charging the power supply and regulating power from the power supply, etc.), a universal serial bus circuity and/or interface converter (e.g., for converting between USB and universal asynchronous receiver/transmitter (UART), etc.), one or more cameras, light emitting diode arrays (e.g., for lighting the cavity of the spherical cap, an external surface of the spherical cap, and/or the like), combinations thereof, and/or the like.

The first circuit may store software that may be executed by the processor of the first circuit (or by other processors of other processing modules). The software may include an operating system, one or more applications, one or more functions, one or more application programming interface (e.g., for interfacing with other modular processing devices, external devices, other processing modules, etc.), firmware, drivers (e.g., for interfacing with one or more hardware components attachable to the modular processing device, and/or the like).

The modular processing device may include a power supply positioned with the cavity of the spherical cap. The power supply is electrically coupled to the power management module of the first circuit. The power supply may provides power to the first circuit via the power management module. The power management module may modulate power consumption of the modular processing device when the power supply is limited and/or when a power source of the modular processing device is below a threshold level. For instance, the modular processing device may include a power source such as a battery for mobile operation of the modular processing device. The power management module may limit power usage by the processor, graphics processor if present, memory units, transceivers, and/or other processing modules to maintain operations of the modular processing device. When the power supply is low (e.g., below the threshold level, etc.), the modular processing device may restrict some functionality, reducing processing resource utilization, and/or restrict access to particular processing modules. When the modular processing device is connected to an external power source, the power management module may cause the processor, memory, other processing modules, etc. to operate unrestricted.

The modular processing device may include a touch-based display positioned over a base of the spherical cap. The touch-based display may present images and/or video, receive input, etc. The touch interface may be capacitive, resistive, infrared-based, combinations thereof, and/or the like. The touch-based display may be electrically coupled to a processing module such as the primary processing module or a display board that is electrically coupled to the primary processing module. The touch-based interface may be used to provide input to the modular processing device, control operations and/or execute functions of the modular processing device, etc.

In some examples, the modular processing device may rotate the presentation by the display so that the display is oriented according to a user. For instance, the modular processing device may have default orientation so that the display presents content accessible to the user (e.g., text is oriented right size up, etc.). The modular processing device may shift the orientation of the display based on a detected movement of the modular processing device (e.g., via a accelerometer and/or gyroscope, etc.). From a default orientation where the user is facing the display of the modular processing device, the modular processing device may shift the presentation of the display when the modular processing device detects a change in pitch (e.g., latitudinal movement along an x-axis), yaw (e.g., longitudinal movement along a y-axis), and/or roll (e.g., rotation movement), etc. In some instances, the modular processing device may only shift the presentation of the display according to roll so that the presentation of the display is always up (relative to the user viewing the display). The shift may be one-to-one (e.g., each degree change in pitch, yaw, and/or roll causes a corresponding degree change in the presentation) or proportional (e.g., a change of ‘x’ for pitch, ‘y’ for yaw, and/or ‘z’ for roll may cause a change in the presentation that is ‘ax’ for the pitch, ‘by’ for the yaw, and/or ‘cz’ for the roll where a, b, and c are real numbers).

The modular processing device may include a second circuit positioned within the cavity of the spherical cap and configured to drive the touch-based display. The second circuit is electrically coupled to the first circuit. The second circuit may receive power from the power supply through the first circuit. The second circuit may be a display board that includes one or more of a camera facing a user of the modular processing device, input interface (e.g., to manage touch input and/or other input devices, etc.), a microphone, a media processor (e.g., image and/or video processor, etc.), a frame buffer, combinations thereof, and/or the like. The second circuit may include one or more connections with the first circuit. The connections may be selected based on the data being transmitted between the first circuit and the second circuit.

The modular processing device may include one or more other circuits in addition to the first circuit and the second circuit. The one or more other circuits may include, but are not limited to, one or more transceivers (e.g., configured to communicate via Wi-Fi, Bluetooth, Zigbee, Z-wave, etc.), power management modules, specialized memory (e.g., low power double data rate (LPDDR) memory, read only memory, cache memory, and/or the like), combinations thereof, and/or the like. Other processing modules may include a display board (e.g., including display drivers, touch-interface drivers, a camera, a microphone, memory, and/or the like), motion tracking sensors (e.g., gyroscope, accelerometer, combination thereof, and/or the like, environmental sensors (e.g., temperature, hygrometer, pressure, combinations thereof, and/or the like), one or more microphones, a speaker array, haptic drivers, a power supply, a power charging regulator (e.g., for charging the power supply and regulating power from the power supply, etc.), a universal serial bus circuity and/or interface converter (e.g., for converting between USB and universal asynchronous receiver/transmitter (UART), etc.), one or more cameras, light emitting diode arrays (e.g., for lighting the cavity of the spherical cap, an external surface of the spherical cap, and/or the like), combinations thereof, and/or the like.

The second circuit and/or the one or more other circuits may connect to the first circuit (and/or to one or more other circuits via interconnections, etc.). The connections may use a transmission protocol based on the data being transmitted over the connection, the source circuit, the destination circuit, and/or the like. For example, some connections may be based on inter-integrated circuit (I2C), inter-integrated circuit sound (I2S) for audio-based data such as microphones or speakers, camera serial interface 2 (CSI-2) for visual data from cameras, serial peripheral interface (SPI) for sensors and/or other peripherals, digital microphone (DMIC) for audio data such as microphones, display serail interface (DSI) for visual data such as visual data transmitted to and/or from a display, DisplayPort (for visual data such as visual data transmitted to and/or from a display), high-definition media interface (HDMI) for visual data such as visual data transmitted to and/or from a display, and/or the like. For example, the second circuit may include one or more connections with the first circuit including, but not limited to, a CSI-2 connection for a camera (e.g., facing the user of the modular processing device), an I2C connection for a light sensor (e.g., configured to modulate a brightness and/or contrast of the display), a media transfer protocol (e.g., DSI, DisplayPort, and/or HDMI for video processing), etc.

The modular processing device may include one or more connectors positioned on an exterior surface of the spherical cap. The one or more connectors are configured to removably affix one or more components to the spherical cap. The external surface of the spherical cap may include one or more connectors configured to removable affix components configured to augment the spherical cap such as software executing on the one or more processing modules. Each connector may be an internal connector (e.g., aperture configured to receive an external connector of a component) or an external connector (e.g., a material that extends from an external surface of the spherical cap or component that is configured to be received by and affixed to an internal connector, etc.). In some configurations, the connectors may include an electrical connection to the primary processing module. The electrical connection enables the modular processing device to provide power to the components affixed to the modular processing device and/or enables the components to provide power to the modular processing device. Alternatively, or additionally, the electrical connection may enable data to be transferred between processing modules and the component. Alternatively, and/or additionally, a data connection (e.g., an alternate data connection and/or a parallel connection) may be established using a transceiver of a processing module (e.g., such as Bluetooth, Wi-Fil, etc.).

The modular processing device may use the data connection to identify the component, determine capabilities of the component, execute one or more functions and/or applications of the modular processing device, and/or the like. For example, connecting a flywheel to the modular processing device may trigger execution of a driving application that presents a virtual environment including a car, a boat, a plane, a spaceship, or the like. The driving application may use motion tracking sensors (e.g., accelerometers and gyroscopes), to track a position and/or orientation of the modular processing device such that moving the flywheel (e.g., rotation, or other movement) causes a corresponding rotation in the view of the virtual environment and the car, boat, plane, spaceship, etc. by the display of the modular processing device.

Examples of connectors include, but are not limited to, a pressure fitting, a locking fitting (e.g., such as bearing-based fitting, etc.), a threaded fitting (e.g., where the internal connector includes threads that engage corresponding threads of an external connector, etc.), magnetic fitting, and/or any other removable fitting. For example, a connector of the spherical cap may include a threaded fitting in which an internal connector of the spherical gap may include threads that engage corresponding threads of an external connector extending from a surface of the connector. For another example, a connector of the spherical cap may be a magnetic connector comprising a magnet covered by a plate that may be flush with the external surface of the spherical cap. A component may comprise a magnet with an opposite polarity from the magnet of the spherical cap such that the attractive forces of the two magnetics cause the spherical cap to be removably affixed to the component.

The spherical cap may be removably affixed to a stand configured to allow operation of the touch-based display while the spherical cap is positioned on a surface by preventing rotation of the spherical gap. The stand may be a spherical segment comprising a first base proximate to a surface and a second base configured to be removable affixed to a connector of the spherical cap. The connector may be positioned on a lower portion of the spherical cap (e.g., below the display, etc.) such that when affixed to the stand the display is facing a user (e.g., approximately perpendicular to the surface, etc.), facing up (e.g., approximately parallel to the surface and facing away therefrom, etc.), or in any other position so as to allow for the operation of the spherical cap and/or any function thereof. In some instances, the connector may be a magnetic connector.

One or more components may be removably affixed to the modular processing device. Each component connected to the modular processing device may augment the functionality of the modular processing device. Alternatively, and/or additionally, the functionality of the modular processing device may be based on which connector the component is connected to. The functionality may be augmented by executing particular functions, executing particular applications, modifying the display of the modular processing device (e.g., such as to adjust for changes detected in the position and/or orientation of the modular processing device, etc.).

Although described in the singular, a modular processing device may include features of any modular processing device described herein including those described in differing examples.

Some implementations of modular processing devices may include hardware components and/or functionality configured for particular user age groups (e.g., such as kids ages 5-12, adolescents ages 13-18, young adults ages 19-24, etc.). A modular processing device configured for children (e.g., ages 5-12, etc.).

In this implementation, the modular processing device comprises a spherical cap defining an internal cavity and a base region. A touch-sensitive display is positioned over the base region of the spherical cap such that the display forms a generally planar interface for presenting visual content and receiving user input from a user. The spherical cap may be formed from impact-resistant materials, such as, but not limited to, acrylonitrile butadiene styrene (ABS), acrylic, fiberglass, steel, polycarbonate, aluminum, combinations thereof, and/or the like. The outer surface of the spherical cap may be smoothed and rounded to reduce sharp edges and may incorporate coatings and/or textures that improve grip and durability for use by target user age group. For instance, younger users may be more likely to drop the modular processing device. For these users, the spherical cap may include coatings and/or textures that increase durability and tactile feedback such (e.g., grip, etc.). The spherical cap of a modular processing device for other user age groups may be less prone to drops or other damage and therefore include different coatings and/or textures that prioritize an appearance of the modular processing over durability or grip.

The modular processing device may include one or more circuits positioned within the cavity of the spherical cap. The one or more circuits may be implemented as one or more printed circuit boards electrically interconnected to form a unified electronic subsystem and may be referred to herein as a primary circuit. The primary circuit may include a processor, one or more memory devices (e.g., non-volatile and/or volatile memory, etc.). In some instances, the primary circuit may also include one or more of: a power management module, one or more display driver circuits for driving the touch-sensitive display, one or more input interface circuits for processing touch input detected at the touch-sensitive display, one or more transceivers for wireless communication (e.g., Wi-Fi, Bluetooth, and/or the like), one or more audio drivers electrically coupled to a speaker and/or microphone, and motion or environmental sensors, combinations thereof, and/or the like. Integrating these functions with the primary circuit may simplify the assembly of the modular processing device and reduce size of the processing components positioned within the cavity of the spherical cap.

In some instances, one or more secondary circuits may be wirelessly or electrically coupled with the primary circuit. The one or more secondary circuits may include one or more of: one or more processors, one or more memories (e.g., non-volatile and/or volatile memory, etc.), one or more graphics processing units (GPUs), one or more tensor processing units (TPUs), one or more application specific integrated circuits (ASIC), one or more field programmable gate arrays (FPGAs), one or more a power management module, one or more display driver circuits for driving the touch-sensitive display, one or more input interface circuits for processing touch input detected at the touch-sensitive display, one or more transceivers for wireless communication (e.g., Wi-Fi, Bluetooth, and/or the like), one or more audio drivers electrically coupled to a speaker and/or microphone, and motion or environmental sensors, combinations thereof, and/or the like. The one or more secondary circuits may be positioned proximate to the primary circuit (e.g., with the cavity of the spherical cap) remotely therefrom (e.g., external to the spherical cap), or some combination thereof. For instance, a secondary circuit may be positioned within an external accessary device affixed to the spherical cap via a connector. This secondary circuit may communicate with the primary circuit wirelessly (e.g., via one or more transceivers) and/or through an electrical connection established via the connector. Using external secondary circuits enables expanding processing capabilities of the modular processing device on demand for particular workloads (e.g., adding processors for parallel processing or increased processing speeds, GPUs for machine-learning tasks, etc.) and externalizing some processing components to save space within the cavity and to reduce heat buildup from the primary circuit.

The primary circuit may store and execute software including control software (e.g., such as an operating system, system drivers for the various electronic or electromechanical components, power management, etc.) and software tailored to particular user groups. For instance, for young user groups, the primary circuit may store games, stories, videos, widgets, and applications suitable for young users. Alternatively, or additionally, the primary circuit may store links to software stored and/or executed from a remote device or service. For other user groups and/or applications of the modular processing device, the primary circuit may store other applications such as productivity software, games configured for the particular user group, applications configured to process particular sensor inputs, etc.

In some implementations, the primary circuit may include one or more machine-learning models or facilitate access to one or more machine-learning models hosted within a remote environment. Examples of machine-learning models include, but are not limited to, neural networks (e.g., such as recurrent neural networks, long short-term memory (LSTM), mask recurrent neural networks, convolutional neural networks, faster convolutional neural networks, deep learning networks, you only look once (YOLO), EfficientDet, deep learning networks, transformers (such as, but not limited to, generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), etc.), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like

The one or more machine-learning models may facilitate unique interactions between a user and the modular processing device. The one or more machine-learning models may include language models, natural language processing models, speech-to-text and/or text-to-speech models, classifiers, image and/or video generation models, etc. The one or more machine-learning models may provide various features for target user group. For example, for young users, the machine-learning models may provide interactive story generation (e.g., where natural language communications from the user may be used as an input prompt for a machine-learning model generating a story with the user), visualizations (e.g., where a machine-learning model generates images and/or videos based on received natural language communications, generated stories, etc.), character generation, character impersonation (e.g., where the machine-learning models generates communications as a generated character), educational games and/or applications (e.g., based on commands and/or prompts provided by users, etc.), creativity tools, combinations thereof, and/or the like.

In some examples, the software may include parental control functions such as time-of-use limits, profile-based content access, machine-learning restrictions (e.g., such restrictions on the use of machine-learning processes, restrictions on the use of user data, etc.), remote management via a companion device, etc. The user interface presented on the touch-sensitive display may employ large touch targets, simplified navigation, and age-appropriate graphics to facilitate use by the young users. For older users, the software and/or machine-learning models may be configured with different services and different user interfaces.

When the primary circuit has sufficient processing resources, the one or more machine-learning models may be stored and executed by the primary circuit. In other instances, additional processing resources may be added via an accessory device. In those instances, the one or more machine-learning models may be stored and executed by the primary circuit, the secondary circuit, and/or some combination thereof. If the primary circuit lacks the processing resources to execute the one or more machine-learning models, then the one or more machine-learning models may be hosted by a remote device (e.g., such as, but not limited to, one or more servers, cloud networks, etc.). In those instances, the modular processing device may still provide the functionality of the one or more machine-learning models without including the processing resources needed to execute the one or more machine-learning models.

The touch-sensitive display may be capacitive, resistive, infrared-based, combinations thereof, and/or the like. The display is electrically coupled to the primary circuit (or a secondary circuit) such that the primary circuit (or the secondary circuit) both drives the visual presentation and receives corresponding touch data. The touch interface may be used to select applications, interact with virtual objects, respond to prompts, control one or more functions triggered by attached accessories, etc. In some examples, the primary circuit may also use sensor data (e.g., from an accelerometer or gyroscope, when present) to adjust the orientation of the displayed content so that the content remains upright relative to the user, even when the spherical cap is rotated.

In some implementations, one or more motors may be positioned with the cavity of the spherical cap. The one or more motors may be positioned at various locations within the cavity. Some motors may be configured to generate a vibration for tactile feedback. For instance, the motors may be configured to rotate a shaft affixed to an unbalanced mass causing a vibration. Some motors may be configured to induce a rotation in the device. For instance, a motor may cause a mass to move along a first rail positioned along the circumference of the inner surface of the spherical shell. The mass may be moved along the first rail causing the spherical shell to move along an axis defined by the rail. A second motor may cause a mass to move along a second rail positioned along the circumference of the inner surface of the spherical shell where the second rail is positioned perpendicular to the first rail. Since the first rail and the second rail may intersect, the primary circuit may drive the first motor and the second motor to ensure the masses of the first rail and the second rail do not collide during operation.

The external surface of the spherical cap includes a plurality of connectors configured to removably affix accessories that augment the functionality of the modular processing device. Each connector may be disposed at a predetermined position on the spherical cap and may be implemented as an internal connector (e.g., an aperture, recess, or socket) or an external connector (e.g., a protruding element configured to be received by a complementary structure on an accessory). The connectors may include mechanical engagement structures such as snap-fit features, locking tabs, threaded portions, magnetic interfaces, and/or the like to allow attachment and removal by a target user group while maintaining secure attachment during normal use. The connectors for a particular modular processing system may be selected based on the target user group. For instance, for younger users, internal connectors (or magnetic interfaces or the like) may be used as younger users may be more likely to damage external connectors or be injured by them. In some instances, the connectors may be designed with size, shape, and/or force thresholds appropriate for a specified age range to reduce the risk of accidental detachment or ingestion.

Some connectors may include an electrical interface between the primary circuit and an attached accessory. The electrical interface may include power lines for providing power from the modular processing device to the accessory or from the accessory to the primary circuit, data lines for communication between the primary circuit and the accessory, identification lines for detecting a type or state of the accessory, and/or the like. In one example, an accessory may include a small circuit (e.g., a resistor network, memory device, microcontroller, ASIC, FPGA, etc.) that, when connected to the connector, allows the primary circuit to identify the accessory based on an electrical signature. In another example, the accessory may communicate with the primary circuit via a serial interface (e.g., I²C, SPI, UART, and/or the like) routed through the connector. In yet another example, the accessory may rely on a wireless interface (e.g., Bluetooth, etc.) for data communication while using the connector only for mechanical attachment (and optionally power delivery).

The modular processing device may execute different applications, functions, and/or operate differently in response to accessories attached via the connectors. For example, attachment of a steering-wheel-shaped accessory may cause the primary circuit to launch a driving or navigation game, where rotation or movement of the modular processing device and/or accessory is translated into control inputs. A presentation on the touch-sensitive display may also be updated based on the rotation or movement of the modular processing. In another example, attachment of a letter-block accessory may trigger an alphabet-learning application that displays letters, words, and animations associated with the letter of the letter-block accessory. In another example, attachment of a musical-instrument accessory (e.g., drum pad, piano-key overlay, etc.) may launch a music application, where touch input on the display and/or signals from the accessory are converted into an audio output.

In some implementations, the accessories may include sensors, lights, motors, actuators, displays, touch-interfaces, input devices (e.g., game controller, mouse, keyboard, etc.), processing resources (e.g., central processing units, memories, GPUs, TPUs, ASICs, FPGAs, etc.), combinations thereof, and/or the like. The accessories may be controlled by the primary circuit to create interactive experiences. For example, an accessory may include one or more light emitting diodes that illuminate in synchronization with content presented on the touch-sensitive display, or haptic elements that vibrate when the child achieves a goal in a game. The primary circuit may provide control signals and power to such elements through the electrical interface of the connector. Alternatively, the accessories may include control process configured to modify and/or control the primary circuit.

The modular processing device may further include a stand configured to support the spherical cap on a surface while permitting operation of the touch-sensitive display. The stand may prevent unintentional rolling of the spherical cap, maintain the touch-sensitive display at an ergonomic viewing angle, allow for projecting images and/or video, etc. The stand may connect to the modular processing device any connector of the modular processing device to enable use of the modular processing device in different orientations. For instance, the stand may be connected to a connector that may be centered relative to a length of the touch sensitive display such that the touch sensitive-display faces the user when placed on the surface. The stand may also be connected to a connector that is approximately opposite the touch-sensitive display on the spherical cap (e.g., approximately opposite the base of the spherical cap) such that the touch sensitive display away from the surface when the modular processing device is placed on the surface. This configuration may enable the touch-sensitive display to project images and/or video onto a ceiling, etc. The stand may be connected to the modular processing device in other configurations to enable other functions of the modular processing device. In some examples, the base may include software, processing resources, and/or any other accessory that may extend the functionality of the modular processing device. Different stands may modify the functionality of the modular processing device differently.

The power supply of the modular processing device may be housed within the cavity of the spherical cap and electrically coupled to the primary circuit. The power supply may include a rechargeable battery managed by the power management module. The power management module may regulate battery charging (e.g., via a USB connector or wireless charging interface), monitor battery level, and adjust operation of the primary circuit based on available power. For example, when the battery level falls below a threshold, the primary circuit may automatically reduce display brightness, disable non-essential wireless modules, or limit access to power-intensive applications (e.g., such as machine-learning models, etc.), which may extend operations of the modular processing device. When the device is connected to an external power source, the power management module may remove such restrictions.

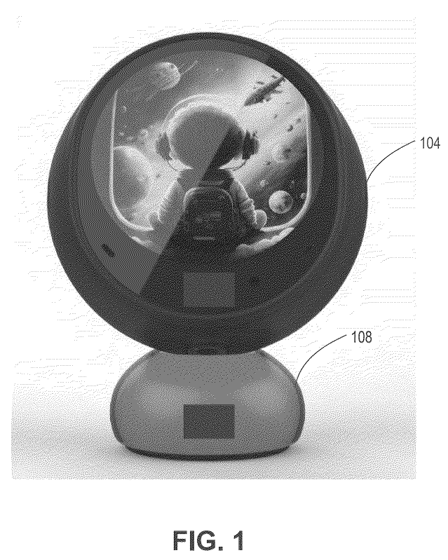

FIG. 1 illustrates a front view of an example modular processing device according to aspects of the present disclosure. Modular processing devices may include a spherical cap and one or more components that may be removably affixed to the spherical cap component. Spherical cap may be formed from impact-resistant materials, such as, but not limited to, acrylonitrile butadiene styrene (ABS), acrylic, fiberglass, steel, polycarbonate, aluminum, combinations thereof, and/or the like. Spherical cap 104 may be a component of a modular processing device comprising processing modules, a touch-based display that can present various forms of media such as images and/or video and receive input from touch, sensors (e.g., motion sensors, environmental sensors, etc.,), cameras, microphones, speakers, combinations thereof, and/or the like. The modular processing device may include a portable power source (e.g., such as a battery, etc.) to enable mobile operations).

The modular processing device may include one or more connectors positioned on spherical cap 104 that enable components to be removably affixed to an external surface of spherical cap 104. Examples of connectors include, but are not limited to, a pressure fitting, a locking fitting (e.g., such as bearing-based fitting, etc.), a threaded fitting (e.g., where the internal connector includes threads that engage corresponding threads of an external connector, etc.), magnetic fitting, and/or any other removable fitting. For example, a connector of spherical cap 104 may be a magnetic connector comprising a magnet covered by a plate that may be flush with the outer surface of spherical cap 104. Stand 108 may comprise a magnet with an opposite polarity from the magnet of spherical cap 104 such that the attractive forces of the two magnetics cause spherical cap 104 to be removably affixed to stand 108. Stand 108 may enable operations of the touch-based display while limiting movement of the spherical cap (e.g., yaw, pitch, and/or roll, etc.). Spherical cap 104 may be removed from stand 108 by pulling stand 108 in an opposite direction from spherical cap 104 overcoming the attractive forces of the magnets.

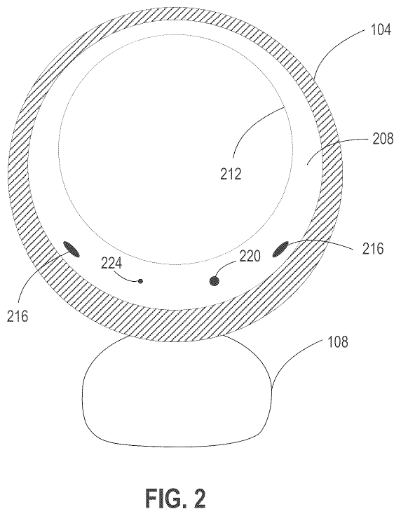

FIG. 2 illustrates example aspects of a modular processing device according to aspects of the present disclosure. The modular processing device of FIG. 2 may be a configuration of THE modular processing device of FIG. 1 (and/or any other figure). The modular processing device includes spherical cap 104 and may be removably affixed to stand 108. Spherical cap 104 includes a display positioned over a base of spherical cap 104. The display includes surface 212, which may be a smooth surface comprising a transparent or translucent materials such as plastic, glass, resin, and/or the like. Surface 212 within surface 208 may be the portion of the display that presents media (e.g., such as images, video, etc.). In some examples, surface 208 may be black or approximately black so that when surface 212 is turned off, the display comprises a uniform appearance. In other examples, surface 212 may be equal in size to surface 208 rather than small than surface 208 as shown.

Surface 208 may include one or more apertures and/or transparent sections that allow sensors within spherical cap 104 to receive input from external environments. For example, the one or more transparent sections may pass light to light sensors (e.g., light sensors 216, etc.) and/or camera 220. Surface 208 may include aperture configured to allow sound to reach microphone 224. Surface 208 may include other apertures and/or transparent sections based on the sensors of a particular configuration of the modular processing device. For example, surface 208 may include one or more apertures for one or more speakers.

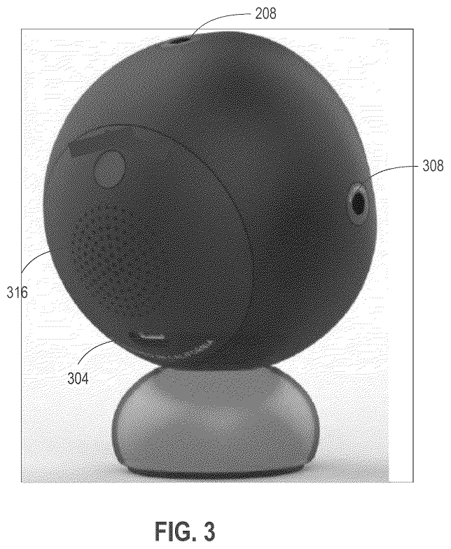

FIG. 3 illustrates a rear view of an example modular processing device according to aspects of the present disclosure. The rear view of the modular processing device includes a view of a rear portion of spherical cap 104. The rear portion of spherical cap 104 includes access port 304, connectors 308, and speaker port 316. Access port 304 may be configured to provide power and/or data to the modular processing device. Access port 304 may be electrically coupled to processing modules of the modular processing device. For example, access port 304 may be a universal serial bus port that allows for power and data to be provided over a same connection. Connectors 308 are internal connectors that may receive external connectors of one or more components. The modular processing device may include one or more connectors positioned on the external surface of spherical cap 104 In some example, relative to a default position of spherical cap 104 (e.g., depicted in FIG. 1 and FIG. 2), spherical cap 104 may include connectors 308 positioned on top of spherical cap 104, on the bottom of spherical cap 104, on each side of spherical cap 104, etc. In other examples, spherical cap 104 may include connectors over any portion of the external surface of spherical cap 104 apart from the display. Spherical cap 104 may include speaker port 316 that allows sound from a speaker within spherical cap 104 to be audible outside spherical cap 104.

The external surface of spherical cap 104 may include other apertures, ports, and/or transparent portions for speakers, cameras, and/or sensors of the modular processing device. For example, spherical cap 104 may include a rear transport portion proximate to speaker port 316 configured to allow light to reach a rear-facing camera of the modular processing device.

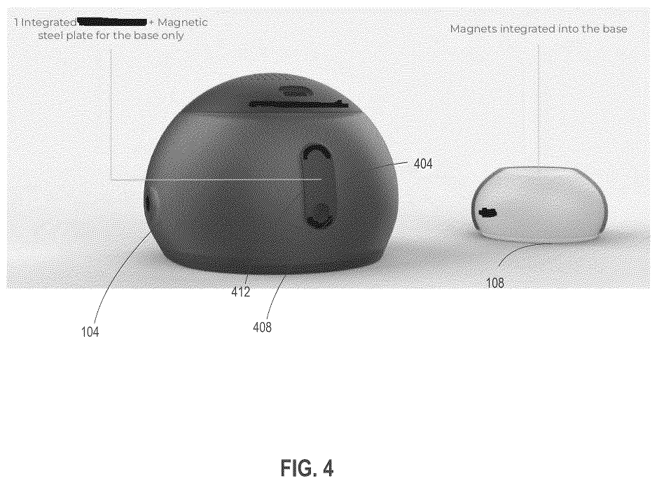

FIG. 4 illustrates a bottom view of an example modular processing device separated from a stand according to aspects of the present disclosure. The bottom view of the modular processing device includes a connector configured to removably affix the modular processing device to one or components (e.g., such as stand 108 as shown). Connector 404 may allow for one or more connection types. For instance, a first connection type may be aperture 408, which may be an internal connector that may receive a corresponding external connector of a component. A second connection type may be plate 412, which may cover a magnet that may removably affix connector 404 to magnetic components such as stand 108.

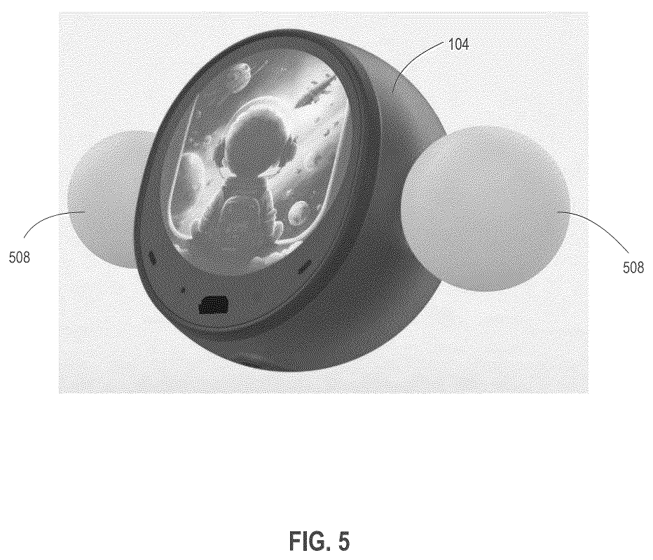

FIG. 5 illustrates an example configuration of a modular processing device including spherical handles affixed to the modular processing device according to aspects of the present disclosure. The modular processing device of FIG. 5 includes two handles affixed to spherical cap 104 of a modular processing device. Handle 508 may be positioned at any connector of spherical cap 104 such as on the left and right side of a display surface, under the display surface, and/or the like. In some examples, handle 508 may be spherical in shape as shown to complement the spherical shape of spherical cap 104. In other examples, handle 508 may comprise other shapes such as ovals, cylinders, rectangular prisms, and/or the like. Handle 508 may be of any shape. Each handle 508 may be the same or different shapes. Handle 508 may comprise a rigid or semi-rigid material that allows a user to hold the handles in place of holding spherical cap 104. Handle 508 may include an external connector (not shown) that may engage an internal connector of spherical cap 104. The connector may be a bearing-type connector and/or any aforementioned connector type.

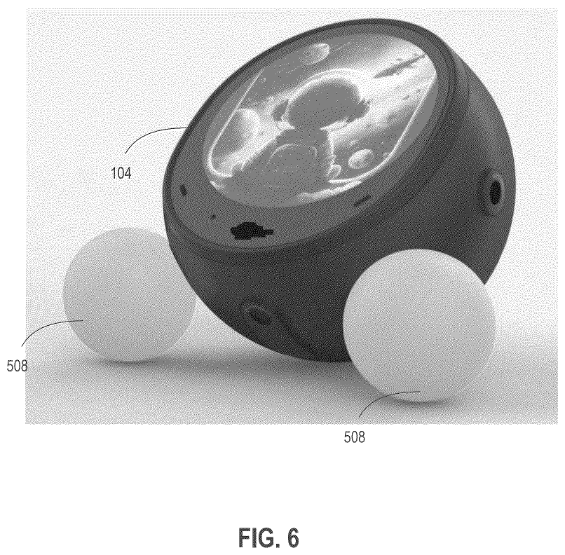

FIG. 6 illustrates another example configuration of a modular processing device including two spherical handles affixed to the modular processing device according to aspects of the present disclosure. The modular processing device of FIG. 5 includes two handles affixed to spherical cap 104 of a modular processing device. Handle 508 may be positioned in an alternate position than as shown in FIG. 5. For example, if a user is viewing the display of the spherical cap 104 (e.g., as shown in FIG. 1 and FIG. 2) and spherical cap is represented as a circle, then the connectors of FIG. 5 may include a connector positioned at 0 degrees (e.g., the right portion of spherical cap 104), 90 degrees (e.g., a top portion of spherical cap), 180 degrees (e.g., the left portion of spherical cap 104), and 270 degrees (e.g., the bottom of spherical cap 104), etc. The connectors of FIG. 6 may include a connector positioned at approximately 225 degrees (e.g., diagonally the bottom left portion of spherical cap 104) and a connector at approximately 325 degrees (e.g., diagonally the bottom right portion of spherical cap 104). Handle 508 of FIG. 6 may be positioned so as to provide two stands for spherical cap 104 (e.g., in place of stand 108) to provide stability and a viewing angle of the display.

Spherical cap 104 may include connectors positioned at any point of the external surface of spherical cap 104 to enable connection of different components. In some examples, spherical cap 104 may include a rail positioned around the circumference of spherical cap 104. The rail may include connectors positioned thereon. The connectors may slide along the rail to different positions on the rail to allow for dynamic connection locations.

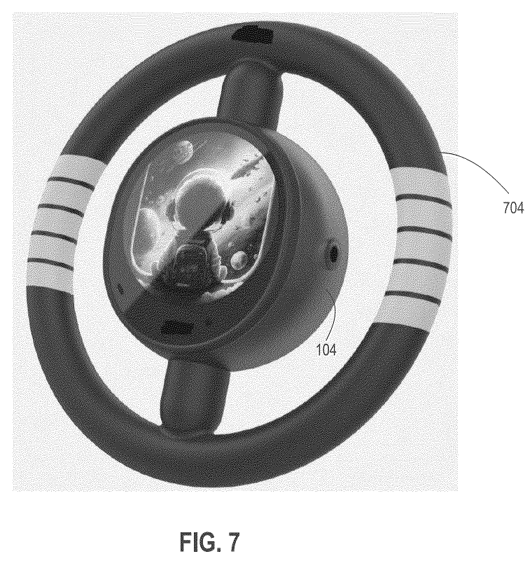

FIG. 7 illustrates another example configuration of a modular processing device including to a flywheel attached to the modular processing device to allow for execution of particular functions of the modular processing device according to aspects of the present disclosure. The modular processing device may support different component types that may augment the functionality of the modular processing device or assist in providing input. For example, flywheel 704 may connect to a connector at the bottom of spherical cap 104 (e.g., at 270 degrees) and a connector at the top of spherical cap 104 (e.g., at 90 degrees). Flywheel 704 may have an appearance of a steering wheel of a car or other directional control apparatus. Flywheel 704 may provide handles for spherical cap 104 while allowing for causing a roll movement. The modular processing device may include one or more motion sensors such as gyroscope and/or accelerometer configured to track three or six degrees of movement. In some examples, the modular processing device may display a virtual environment including a vehicle that can be controlled by rotating flywheel 704. When flywheel 704 is rotated a corresponding rotation may be caused in the virtual environment.

In some examples, the motion sensors of the modular processing device may be used to stabilize an appearance of the display during motion. The modular processing device may first define a default position and/or orientation of the modular processing device. The default position and/or orientation may be preset or defined when the component such as flywheel 704 is connected. In some examples, the default position and/or orientation of the modular processing device may correspond to the position and/or orientation of FIG. 1 and FIG. 2 with camera 220 of the display positioned below surface 212. The default position and/or orientation of the display may allow for a user to read text right-side up, etc. Once defined, when the modular processing device detects a roll, the modular processing device may modify the presentation of media by the display so that the presentation of media does not change relative to the user viewing the display. For example, the user may rotate the modular processing device using flywheel 704, but the display will not appear to rotate relative to the user. Alternatively, the display may cause the presentation of the media to rotate with the modular processing device. For example, the display may be present media in a fixed orientation that may not change even when the modular processing device rotates (or otherwise changes position and/or orientation).

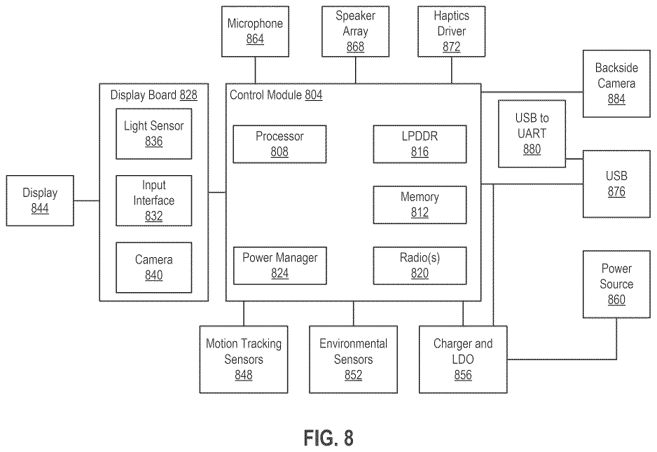

FIG. 8 illustrates a block diagram of example processing modules of a modular processing device according to aspects of the present disclosure. A modular processing device may include one or more processing modules. In some configurations, the modular processing device may include control module 804 as a primary processing module that may connect other processing modules. In other configurations, the modular processing device may include a bus module that control module 804 connects to other processing modules. In this configuration, processing modules may be added and/or removed to augment the capabilities of the modular processing device.

Control module 804 may include processor 808, memory 812 (e.g., volatile and/or non-volatile memory, etc.), low power double data rate (LPDDR) memory, one or more transceivers 820, power manager 824, combinations thereof, and/or the like. One or more transceivers may enable communication via any wireless protocol such as, but not limited to, Wi-Fi, Bluetooth, Zigbee, Z-wave, and/or any other wireless protocol. Power manager 824 may control power to modules of control module 804 and/or other processing modules. For example, when operating with limited power (e.g., via internal power source 860), power manager 824 may control resource utilization to stabilize processing performance, maximize system uptime, prevent power interruptions or data corruption resulting therefrom (e.g., such as when power source 860 may be depleted during a read/write operation, etc.), combinations thereof, and/or the like. In some examples, control module 804 may include other modules such as graphics processing units (GPUs), artificial intelligence cores, etc.

Memory 812 may store software, firmware, drivers, and/or the like that enable operations of the modular processing device. For example, the software may include an operating system, firmware, drivers for the various electronic or electromechanical components, power management, etc., software tailored to a particular user or user group, combinations thereof, and/or the like. For instance, for young user groups, the software may include games, stories, videos, widgets, and applications suitable for young users. For other user groups and/or applications of the modular processing device, the primary circuit may store other applications such as productivity software, media configured for the particular user group, etc. In other applications, the modular processing device may be configured to process sensor input. In those instances, the software may be configured to process receive sensor measurements, transmit sensor measurements and/or processed sensor measurements, generate summaries and reports, etc. In some implementations, the software may not be stored and/or executed by the modular processing device. In those implementations, the modular processing device may include links to software stored and/or executed from a remote device or service. In those instances, the modular processing device may operate similar to a thin client for the software executed remotely.

Memory 812 may store one or more machine-learning models and/or facilitate access to one or more machine-learning models hosted within a remote environment. Examples of machine-learning models include, but are not limited to, neural networks (e.g., such as recurrent neural networks, long short-term memory (LSTM), mask recurrent neural networks, convolutional neural networks, faster convolutional neural networks, deep learning networks, you only look once (YOLO), EfficientDet, deep learning networks, transformers (such as, but not limited to, generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), etc.), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like

The one or more machine-learning models may facilitate unique interactions between users and the modular processing device. The one or more machine-learning models may include language models, natural language processing models, speech-to-text and/or text-to-speech models, classifiers, image and/or video generation models, etc. The one or more machine-learning models may provide various features based on an age or capability of a user. For example, for young users, the machine-learning models may provide interactive story generation (e.g., where natural language communications from the user may be used as an input prompt for a machine-learning model generating a story with the user), visualizations (e.g., where a machine-learning model generates images and/or videos based on received natural language communications, generated stories, etc.), character generation, character impersonation (e.g., where the machine-learning models generates communications as a generated character), educational games and/or applications (e.g., based on commands and/or prompts provided by users, etc.), creativity tools, combinations thereof, and/or the like. For older users, the machine-learning models may be provide agentic services, task facilitation, productivity processes, etc.

In some examples, memory 812 may include parental control functions such as time-of-use limits, profile-based content access, machine-learning restrictions (e.g., such restrictions on the use of machine-learning processes, restrictions on the use of user data, etc.), remote management via a companion device, etc.

Another processing module may include display board 828, which may drive display 844. Display board 828 may include a display driver (e.g., configured to receive video data from control module 804 and process the video data for display by display 844, etc.), input interface 832 (e.g., which process touch-based input from display 844, etc.), light sensor 836 (e.g., which may be used by display board 828 to manage brightness and/or contrast settings of display 844), camera 840 (e.g., front-facing camera positioned to capture a view from the surface of display 844 such as the user), combinations thereof, and/or the like. In some examples, display board 828 may include one or more connections to control module 804. For example, sensors such as light sensor 836 may be connected via I2C or any other data connection, input interface and/or display driver may be connected via DisplayPort, HDMI, and/or DSI connections (or other display-based connection type). Camera 840 may be connected via CSI-2 or the like.

Other processing modules may include, but are not limited to motion tracking sensors 848 such as accelerometers and/or gyroscopes (e.g., which may be independent or combined into a single integrated circuit) connected to control module 804 via an SPI connection or the like, environmental sensors 852 (e.g., such as temperature sensors, hygrometers, pressure sensors, etc.), connected to control module 804 via I2C or the like, microphone 864 connected to control module 804 via DMIC, speaker array (e.g., including one or more speakers for mono, stereo, directional, etc. audio) connected to control module 804 via I2S, haptics driver (e.g., controlling haptic feedback, etc.) connected to control module 804 via I2C, USB to UART 880 (e.g., which receives USB and outputs UART to control module 804, etc.), backside camera 884 connected to control module 804 via CSI-2.

USB 876 may be directly connected to control module 804 and to charger and low dropout regulator (LDO) 856 and connected to USB to UART 880. The direct connection to control module 804 allows for direct power delivery (e.g., via 12 volt power line or the like). Charger and LDO 856 may receive power from USB 876 as well and charge power source 860 (e.g., a battery, power cell, etc.). The low dropout regulator may cause power to automatically switch from USB 876 to power source 860 and/or vice versa during sudden changes in voltage to prevent interruptions to the operations of control module 804 and/or processing modules connected thereto. prevent lower power from USB 876 from causing. When USB 876 is disconnected, power source 860 may supply power to charger and LDO 856, which may pass the power to control module 804. USB 876 may allow data transfers between control module 804 and external devices through USB to UART 880. USB to UART 880 operates as a bridge between USB protocols and UART protocols that may be accepted by control module 804. In some examples, such as when other protocols are used, another interface may be used to convert between USB and the other protocol or the other protocol to UART.

In some examples, control module 804 may include data and/or power connections to connectors positioned on a surface of spherical cap 104. The power connection may be facilitated through charger and LDO 856 to prevent low power drop out situations. The data connection may connect external devices to control module 804 such as other modular processing devices, components, and/or the like. In some configurations, modular processing devices may be daisy-chained together via connectors. In those configurations, a particular control module (e.g., a instance of control module 804) may be selected to control operations of the daisy-chained modular processing devices.

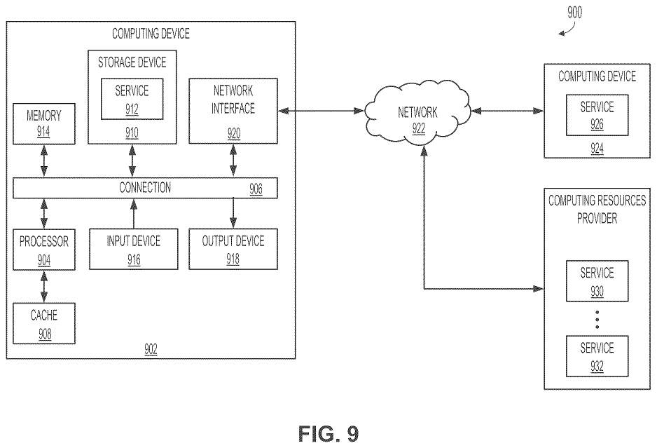

FIG. 9 illustrates an example computing device architecture of an example modular processing device according to aspects of the present disclosure. The example computing system 900 illustrated in FIG. 9 includes a modular processing device 902, which has various components in electrical communication with each other using a connection 906, such as a bus, in accordance with some implementations. The example computing system architecture 900 includes a processor 904 that is in electrical communication with various system components, using the connection 906, and including the memory 914. In some examples, the memory 914 includes read-only memory (ROM), random-access memory (RAM), and other such memory technologies including, but not limited to, those described herein. In some examples, the example computing system architecture 900 includes a cache 908 of high-speed memory connected directly with, in close proximity to, or integrated as part of the processor 904. The system architecture 900 can copy data from the memory 914 and/or the storage device 910 to the cache 908 for quick access by the processor 904. In this way, the cache 908 can provide a performance boost that decreases or eliminates processor delays in the processor 904 due to waiting for data. Using modules, methods and services such as those described herein, the processor 904 can be configured to perform various actions. In some examples, the cache 908 may include multiple types of cache including, for example, level one (L1) and level two (L2) cache. The memory 914 may be referred to herein as system memory or computer system memory. The memory 914 may include, at various times, elements of an operating system, one or more applications, data associated with the operating system or the one or more applications, or other such data associated with the modular processing device 902.

Other memory can be available for use as well. The memory 914 can include multiple different types of memory with different performance characteristics. The processor 904 can include any general-purpose processor and one or more hardware or software services, such as service 912 stored in storage device 910, configured to control the processor 904 as well as a special-purpose processor where software instructions are incorporated into the actual processor design. The processor 904 can be a completely self-contained computing system, containing multiple cores or processors, connectors (e.g., buses), memory, memory controllers, caches, etc. In some examples, such a self-contained computing system with multiple cores is symmetric. In some examples, such a self-contained computing system with multiple cores is asymmetric. In some examples, the processor 904 can be a microprocessor, a microcontroller, a digital signal processor (“DSP”), or a combination of these and/or other types of processors. In some examples, the processor 904 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 900, an input device 916 can represent any number of input mechanisms, such as a microphone for speech, a touch-sensitive screen for gesture or graphical input, keyboard, mouse, motion input, pen, and other such input devices. An output device 918 can also be one or more of a number of output mechanisms known to those of skill in the art including, but not limited to, displays, monitors, speakers, printers, haptic devices, and other such output devices. In some instances, multimodal systems can enable a user to provide multiple types of input to communicate with the computing system architecture 900. In some examples, the input device 916 and/or the output device 918 can be coupled to the modular processing device 902 using a remote connection device such as, for example, a communication interface such as the network interface 920 described herein. In such examples, the communication interface can govern and manage the input and output received from the attached input device 916 and/or output device 918. As may be contemplated, there is no restriction on operating on any particular hardware arrangement and accordingly the basic features here may easily be substituted for other hardware, software, or firmware arrangements as they are developed.

In some examples, the storage device 910 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 910 can include hardware and/or software services such as service 912 that can control or configure the processor 904 to perform one or more functions including, but not limited to, the methods, processes, functions, systems, and services described herein in various examples. In some examples, the hardware or software services can be implemented as modules. As illustrated in example computing system architecture 900, the storage device 910 can be connected to other parts of the modular processing device 902 using the connection 906. In some examples, a hardware service or hardware module such as service 912, that performs a function can include a software component stored in a non-transitory computer-readable medium that, in connection with the necessary hardware components, such as the processor 904, connection 906, cache 908, storage device 910, memory 914, input device 916, output device 918, and so forth, can carry out the functions such as those described herein.

The disclosed systems and services can be performed using a computing system such as the example computing system illustrated in FIG. 9, using one or more components of the example computing system architecture 900. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the media device described herein by, for example, executing code using a processor such as processor 904 wherein the code is stored in memory such as memory 914 as described herein. One or more of a user device, a provider server or system, a database system, or other such devices, services, or systems may include some or all of the components of the computing system such as the example computing system illustrated in FIG. 9, using one or more components of the example computing system architecture 900 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 928. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 904 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 914 can be coupled to the processor 904 by, for example, a connector such as connection 906, or a bus. As used herein, a connector or bus such as connection 906 is a communications system that transfers data between components within the modular processing device 902 and may, in some examples, be used to transfer data between computing devices. The connection 906 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 914 can include random access memory (RAM) including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 914 can also include magnetic or optical data storage media including read-only (e.g., CD ROM and DVD ROM) or otherwise (e.g., CD or DVD). The memory can be local, remote, or distributed.

As described above, the connection 906 (or bus) can also couple the processor 904 to the storage device 910, which may include non-volatile memory or storage, a drive unit, and/or the like. In some examples, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some examples, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some examples (e.g., for large programs) it may not be possible to store the entire program and/or data in the memory at any one time. In such examples, the program and/or data can be moved in and out of memory from, for example, an additional storage device such as storage device 910. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 906 can also couple the processor 904 to a network interface device such as the network interface 920. The interface can include one or more of a modem or other such network interfaces including, but not limited to those described herein. It will be appreciated that the network interface 920 may be considered to be part of the modular processing device 902 or may be separate from the modular processing device 902. The network interface 920 can include one or more of an analog modem, Integrated Services Digital Network (ISDN) modem, cable modem, token ring interface, satellite transmission interface, or other interfaces for coupling a computer system to other computer systems. In some examples, the network interface 920 can include one or more input and/or output (I/O) devices. The I/O devices can include, by way of example but not limitation, input devices such as input device 916 and/or output devices such as output device 918. For example, the network interface 920 may include a keyboard, a mouse, a printer, a scanner, a display device, and other such components. Other examples of input devices and output devices are described herein. In some examples, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some examples, the modular processing device 902 can be connected to one or more additional computing devices such as computing device 924 via a network 922 using a connection such as the network interface 920. In such examples, the computing device 924 may execute one or more services to perform one or more functions under the control of, or on behalf of, programs and/or services operating on modular processing device 902. In some examples, a computing device such as computing device 924 may include one or more of the types of components as described in connection with modular processing device 902 including, but not limited to, a processor such as processor 904, a connection such as connection 906, a cache such as cache 908, a storage device such as storage device 910, memory such as memory 914, an input device such as input device 916, and an output device such as output device 918. In such examples, the computing device 924 can carry out the functions such as those described herein in connection with modular processing device 902. In some examples, the modular processing device 902 can be connected to other modular processing devices (e.g., via a transceiver, connectors, etc.) and/or to a plurality of computing devices such as computing device 924. Each of the other modular processing devices and/or computing devices may also be connected to modular processing devices and/or computing devices. Such a configuration may be referred to herein as a distributed computing environment.

The network 922 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 922 can be wired connections, wireless connections, or combinations thereof. Communications via the network 922 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 922, within the modular processing device 902, within the computing device 924, or within the computing resources provider 928 can include information, which also may be referred to herein as content. The information may include text, graphics, audio, video, haptics, and/or any other information that can be provided to a user of the computing device such as the modular processing device 902. In some examples, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the modular processing device 902 and presented to a user of the modular processing device 902 using forms that are perceptible via sight, sound, smell, taste, touch, or other such mechanisms. In some examples, communications over the network 922 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some examples, the modular processing device 902 and/or the computing device 924 can be connected to a computing resources provider 928 via the network 922 using a network interface such as those described herein (e.g., network interface 920). In such examples, one or more systems (e.g., service 930 and service 932) hosted within the computing resources provider 928 (also referred to herein as within “a computing resources provider environment”) may execute one or more services to perform one or more functions under the control of, or on behalf of, programs and/or services operating on modular processing device 902 and/or computing device 924. Systems such as service 930 and service 932 may include one or more computing devices such as those described herein to execute computer code to perform the one or more functions under the control of, or on behalf of, programs and/or services operating on modular processing device 902 and/or computing device 924.

For example, the computing resources provider 928 may provide a service, operating on service 930 to store data for the modular processing device 902 when, for example, the amount of data that the modular processing device 902 exceeds the capacity of storage device 910. In another example, the computing resources provider 928 may provide a service to first instantiate a virtual machine (VM) on service 932, use that VM to access the data stored on service 932, perform one or more operations on that data, and provide a result of those one or more operations to the modular processing device 902. Such operations (e.g., data storage and VM instantiation) may be referred to herein as operating “in the cloud,” “within a cloud computing environment,” or “within a hosted virtual machine environment,” and the computing resources provider 928 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 928 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 930 and service 932 may implement versions of various services (e.g., the service 912 or the service 926) on behalf of, or under the control of, modular processing device 902 and/or computing device 924. Such implemented versions of various services may involve one or more virtualization techniques so that, for example, it may appear to a user of modular processing device 902 that the service 912 is executing on the modular processing device 902 when the service is executing on, for example, service 930. As may also be contemplated, the various services operating within the computing resources provider 928 environment may be distributed among various systems within the environment as well as partially distributed onto computing device 924 and/or modular processing device 902.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a processing system comprising: a spherical cap comprising a cavity; one or more processing modules positioned within the cavity of the spherical cap, wherein the one or more processing modules include a processor and memory; a touch-based display positioned over a base of the spherical cap, wherein the touch-based display is electrically coupled to a processing module of the one or more processing modules; and one or more connectors configured to removable affix components configured to augment the spherical cap.

Example 2 is the processing system of example(s) 1, further comprising: a circular base removably affixed to the spherical cap via a first connector of the one or more connectors, wherein the circular base operates as a stand for the spherical cap.

Example 3 is the processing system of example(s) 2, wherein the first connector includes a magnetic portion, and wherein the magnetic portion is an opposite polarity from a corresponding magnetic portion of the circular base.

Example 4 is the processing system of example(s) 1, wherein a first connector and a second connector of the one or more connectors are positioned on opposite sides of the spherical cap.

Example 5 is the processing system of example(s) 4, wherein a first handle and a second handle are configured to be affixed to spherical cap via the first connector and the second connector respectively, wherein the first handle and the second handle are handholds for the spherical cap.

Example 6 is the processing system of example(s) 5, wherein the first handle is spherically shaped.

Example 7 is the processing system of example(s) 5, wherein the first handle is cylindrically shaped.

Example 8 is the processing system of example(s) 1, further comprising: one or more sensors electrically coupled to a processing module of the one or more processing modules.

Example 9 is the processing system of example(s) 8, wherein the one or more sensors are usable to define an orientation of the spherical cap.

Example 10 is the processing system of example(s) 8, wherein the one or more sensors include a microphone and a camera, and wherein the camera is positioned relative to the base of the spherical cap.

Example 11 is the processing system of example(s) 1, wherein the spherical cap further includes: a speaker electrically coupled to the one or more processing modules.

Example 12 is the processing system of example(s) 1, wherein the spherical cap further includes: a power source configured to provide power to the display and the one or more processing modules.

Example 13 is the processing system of example(s) 1, wherein the one or more processing modules include one or more of a Wi-Fi radio and a Bluetooth radio.

Example 14 is the processing system of example(s) 1, wherein the one or more connectors are electrically coupled to the one or more processing modules.

Example 15 is a processing system comprising: a spherical cap comprising a cavity; a first circuit positioned within the cavity of the spherical cap, wherein the first circuit comprises a processor and memory; a power supply positioned within the cavity of the spherical cap, wherein the power supply is electrically coupled to the power management module of the first circuit, and wherein the power supply provides power to the first circuit; a touch-based display positioned over a base of the spherical cap; a second circuit positioned within the cavity of the spherical cap and configured to drive the touch-based display, wherein the second circuit is electrically coupled to the first circuit, and wherein the second circuit receives power from the power supply through the first circuit; and one or more connectors positioned on an exterior surface of the spherical cap, wherein the one or more connectors are configured to removably affix one or more components to the spherical cap.

Client devices, user devices, processing devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some examples, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the modular processing device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the examples and/or embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate examples and/or embodiments and does not impose a limitation on the scope unless otherwise claimed. Such language in the specification should not be construed as indicating any non-claimed element is required for the practice of the examples and/or embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A processing system comprising:
a spherical cap comprising a cavity;
one or more processing modules positioned within the cavity of the spherical cap, wherein the one or more processing modules include a processor and memory;
a touch-based display positioned over a base of the spherical cap, wherein the touch-based display is electrically coupled to a processing module of the one or more processing modules; and
one or more connectors configured to removably affix components configured to augment the spherical cap.

2. The processing system of claim 1, further comprising:
a circular base removably affixed to the spherical cap via a first connector of the one or more connectors, wherein the circular base operates as a stand for the spherical cap.

3. The processing system of claim 2, wherein the first connector includes a magnetic portion, and wherein the magnetic portion is an opposite polarity from a corresponding magnetic portion of the circular base.

4. The processing system of claim 1, wherein a first connector and a second connector of the one or more connectors are positioned on opposite sides of the spherical cap.

5. The processing system of claim 4, wherein a first handle and a second handle are configured to be affixed to spherical cap via the first connector and the second connector respectively, wherein the first handle and the second handle are handholds for the spherical cap.

6. The processing system of claim 5, wherein the first handle is spherically shaped.

7. The processing system of claim 5, wherein the first handle is cylindrically shaped.

8. The processing system of claim 1, further comprising:
one or more sensors electrically coupled to a processing module of the one or more processing modules.

9. The processing system of claim 8, wherein the one or more sensors are usable to define an orientation of the spherical cap.

10. The processing system of claim 8, wherein the one or more sensors include a microphone and a camera, and wherein the camera is positioned relative to the base of the spherical cap.

11. The processing system of claim 1, wherein the spherical cap further includes:
a speaker electrically coupled to the one or more processing modules.

12. The processing system of claim 1, wherein the spherical cap further includes:
a power source configured to provide power to the display and the one or more processing modules.

13. The processing system of claim 1, wherein the one or more processing modules include one or more of a Wi-Fi radio and a Bluetooth radio.

14. The processing system of claim 1, wherein the one or more connectors are electrically coupled to the one or more processing modules.

15. A processing system comprising:
a spherical cap comprising a cavity;
a first circuit positioned within the cavity of the spherical cap, wherein the first circuit comprises a processor and memory;
a power supply positioned within the cavity of the spherical cap, wherein the power supply is electrically coupled to a power management module of the first circuit, and wherein the power supply provides power to the first circuit;
a touch-based display positioned over a base of the spherical cap;
a second circuit positioned within the cavity of the spherical cap and configured to drive the touch-based display, wherein the second circuit is electrically coupled to the first circuit, and wherein the second circuit receives power from the power supply through the first circuit; and
one or more connectors positioned on an exterior surface of the spherical cap, wherein the one or more connectors are configured to removably affix one or more components to the spherical cap.
